(19) United States
(12) Patent Application Publication
(10) Pub. No.: US 2026/0322045 A1
(43) Pub. Date: Oct. 15, 2026

(54) TRAILER ELECTRICAL CONNECTOR HAVING INTEGRATED VISIBILITY LIGHT

(71) Applicant: Precision Harness, LLC, Taylor, UT (US)

(72) Inventors: Krystina McNamara, West Haven, UT (US); Mark Hatfield, Providence, UT (US)

(21) Appl. No.: 19/647,700

(22) Filed: Apr. 14, 2026

Related U.S. Application Data
(60) Provisional application No. 63/788,699, filed on Apr. 14, 2025.

(51) Int. Cl. H01R 13/717; H01R 13/52; H01R 13/70

(52) U.S. Cl. CPC H01R 13/717; H01R 13/70; H01R 13/7175; H01R 13/7177; H01R 13/5205; H01R 2201/26

(57) ABSTRACT

Examples of the present disclosure include a trailer electrical connector. The electrical trailer connector includes a housing. The housing includes a front section defining an electrical interface end of the housing and a rear section defining an electrical cable engagement end of the housing and extending from the front section. The trailer electrical connector includes at least one visibility light source coupled to the housing. The trailer electrical connector also includes a plurality of electrical connections located at the electrical interface end of the housing. The trailer electrical connector includes electrical cable attached to the electrical cable engagement end of the housing.

### CROSS-REFERENCE TO RELATED APPLICATION

This application claims the benefit of U.S. Provisional Patent Application No. 63/788,699, filed Apr. 14, 2025, which is incorporated herein by reference.

### FIELD

The present disclosure relates generally to vehicle trailers and more particularly to electrical connectors for vehicle trailers.

### BACKGROUND

Vehicle trailers are becoming increasingly popular among consumers. Vehicle trailers are intended to support and facilitate hauling of an object or objects by a vehicle.

Vehicle trailers can be attached to a wide variety of vehicles, so long as the vehicle has a proper towing capacity. For added safety during travel, and regulated by governmental departments of transportation, vehicle trailers include a wiring harness and corresponding trailer lights. The wiring harness includes an electrical connector that is plugged into a corresponding electrical socket in a towing vehicle. Electrical connectivity between the vehicle trailer and the towing vehicle enables activation of the trailer lights by the towing vehicle. The trailer lights include turn signals, brake lights, and reverse lights, which mimic or match operation of the corresponding lights of the towing vehicle.

### SUMMARY

The subject matter of the present disclosure has been developed in response to the present state of the art, and in particular, in response to the problems and needs in the art that have not yet been fully solved by currently available trailer wiring harnesses and storage methods. From the foregoing discussion, it should be apparent that a need exists for an apparatus, a system, and a method that makes use of an electrical connector and its associated trailer wiring harness easier in poor lighting conditions. Accordingly, the subject matter of the present disclosure has been developed to provide a trailer electrical connector with an integrated visibility light, and associated systems and methods, that may overcome many or all of the above-discussed or other shortcomings in the art.

The following is a non-exhaustive list of examples, which may or may not be claimed, of the subject matter, disclosed herein.

Disclosed herein is a trailer electrical connector that includes a housing. The housing includes a front section defining an electrical interface end of the housing and a rear section defining an electrical cable engagement end of the housing and extending from the front section. The trailer electrical connector also includes at least one visibility light source coupled to the housing. The trailer electrical connector further includes a plurality of electrical connections located at the electrical interface end of the housing. The trailer electrical connector additionally includes an electrical cable attached to the electrical cable engagement end of the housing. The preceding subject matter of this paragraph characterizes example 1 of the present disclosure.

The at least one visibility light source includes at least one of a light emitting diode (LED), a quantum dot light source, an organic LED (OLED), a microLED, a laser-based light source, a nanowire LED, a high-intensity discharge (HID) bulb, or an incandescent bulb. The preceding subject matter of this paragraph characterizes example 2 of the present disclosure, wherein example 2 also includes the subject matter according to example 1, above.

The trailer electrical further includes a switch that selectively powers the at least one visibility light source. The switch includes at least one of a push button, a toggle, a rocker, a slide switch, a momentary contact switch, a photocell, or a passive infrared (PIR) sensor. The preceding subject matter of this paragraph characterizes example 3 of the present disclosure, wherein example 3 also includes the subject matter according to any of examples 1-2, above.

The switch includes at least one of a light-sensing element or a motion-sensing element configured to automatically activate the at least one visibility light source in response to at least one of a detected ambient light level or a detected motion. The preceding subject matter of this paragraph characterizes example 4 of the present disclosure, wherein example 4 also includes the subject matter according to example 3, above.

The at least one visibility light source generates light at an intensity of at least 20 lumens. The preceding subject matter of this paragraph characterizes example 5 of the present disclosure, wherein example 5 also includes the subject matter according to any of examples 1-4, above.

The housing further includes at least two handles located on opposing sides of the trailer electrical connector. The at least one visibility light source includes multiple visibility light sources. The multiple visibility light sources are located between the at least two handles. The preceding subject matter of this paragraph characterizes example 6 of the present disclosure, wherein example 6 also includes the subject matter according to any of examples 1-5, above.

The at least one visibility light source is located on the electrical interface end of the housing. The preceding subject matter of this paragraph characterizes example 7 of the present disclosure, wherein example 7 also includes the subject matter according to any of examples 1-6, above.

The at least one visibility light source is oriented to face a direction substantially perpendicular to the electrical interface end of the housing. The preceding subject matter of this paragraph characterizes example 8 of the present disclosure, wherein example 8 also includes the subject matter according to example 7, above.

The housing further includes a power supply receptacle formed in an external surface of the housing and a cover removably received by the external surface and substantially flush with the external surface. The trailer electrical connector further includes a power supply. The power supply is attached to the cover such that the power supply is received by the power supply receptacle when the cover is received by the external surface, powers the at least one visibility light source. The at least one visibility light source is within and attached to the cover. The preceding subject matter of this paragraph characterizes example 9 of the present disclosure, wherein example 9 also includes the subject matter according to any of examples 1-8, above.

The cover further includes a first cover surface extending in a first direction substantially perpendicular to a length of the housing. The at least one visibility light source is coupled to the housing at and located within the first cover surface. The cover also includes a second cover surface extending in a second direction different from the first direction. The cover additionally includes a button located on the second cover surface and operable to remove the cover from the external surface. The preceding subject matter of this paragraph characterizes example 10 of the present disclosure, wherein example 10 also includes the subject matter according to example 9, above.

The housing further includes a magnet receptacle formed in an external surface of the housing and a magnet is within and attached to the receptacle such that the magnet does not move relative to the housing. The preceding subject matter of this paragraph characterizes example 11 of the present disclosure, wherein example 11 also includes the subject matter according to any of examples 1-10, above.

The at least one visibility light source is located within the housing on the opposite side of the housing as the magnet. The preceding subject matter of this paragraph characterizes example 12 of the present disclosure, wherein example 12 also includes the subject matter according to example 11, above.

The housing includes an external surface extending substantially perpendicular to a length of the housing and the at least one visibility light source is located within the external surface. The preceding subject matter of this paragraph characterizes example 13 of the present disclosure, wherein example 13 also includes the subject matter according to any of examples 1-12, above.

The external surface is substantially parallel to the electrical interface end. The preceding subject matter of this paragraph characterizes example 14 of the present disclosure, wherein example 14 also includes the subject matter according to example 13, above.

The plurality of electrical connections are configured to mate with a plurality of vehicle electrical connections of a vehicle electrical connector and at least one visibility light source indicates a connection status between the trailer electrical connector and the vehicle electrical connector. The preceding subject matter of this paragraph characterizes example 15 of the present disclosure, wherein example 15 also includes the subject matter according to any of examples 1-14, above.

The at least one visibility light source faces toward the plurality of electrical connections. The preceding subject matter of this paragraph characterizes example 16 of the present disclosure, wherein example 16 also includes the subject matter according to any of examples 1-15, above.

The trailer electrical connector further includes a switch located on or within the housing. The switch is operable to selectively activate the at least one visibility light source independently of whether power is supplied to the plurality of electrical connections. The preceding subject matter of this paragraph characterizes example 17 of the present disclosure, wherein example 17 also includes the subject matter according to any of examples 1-16, above.

The at least one visibility light source is operable in at least one selectable modes. The at least one selecting mode comprises at least one of: a high-intensity mode, a low-intensity mode, a strobe mode, an SOS signaling mode, a beacon mode, or an adjustable-focus mode. The preceding subject matter of this paragraph characterizes example 18 of the present disclosure, wherein example 18 also includes the subject matter according to any of examples 1-17, above.

The trailer electrical connector further includes a rechargeable power supply housed within the housing. The rechargeable power supply is configured to be recharged by at least one of a vehicle when the trailer electrical connector is electrically connected to the vehicle, a trailer battery, a solar panel coupled to the housing, or an external power source. The preceding subject matter of this paragraph characterizes example 19 of the present disclosure, wherein example 19 also includes the subject matter according to any of examples 1-18, above.

The housing has a non-circular cross-sectional shape and the electrical interface end is configured to mate with a vehicle electrical connector having a vehicle electrical interface with four or more electrical connections. The preceding subject matter of this paragraph characterizes example 20 of the present disclosure, wherein example 20 also includes the subject matter according to any of examples 1-19, above.

The four or more electrical connectors are configured for at least one of vehicle connection, accessory connection, safety connection, dormant connection, or blank connection. The preceding subject matter of this paragraph characterizes example 21 of the present disclosure, wherein example 21 also includes the subject matter according to example 20, above.

Further disclosed herein is a system that includes a trailer electrical connector. The trailer electrical connector includes a trailer-connector housing. The trailer-connector housing includes a front section defining a trailer electrical interface end of the housing and a rear section defining a trailer electrical cable engagement end of the housing and extending from the front section. The trailer-connector housing also includes at least one visibility light source coupled to the trailer-connector housing. The trailer-connector housing further includes a plurality of trailer electrical connections located at the trailer electrical interface end of the trailer-connector housing. The trailer-connector housing additionally includes a trailer-connector electrical cable attached to the trailer electrical cable engagement end of the trailer-connector housing. The system also includes a vehicle electrical connector. The vehicle electrical connector includes a vehicle-connector housing including a vehicle electrical interface end and a vehicle electrical cable engagement end. The vehicle electrical connector also includes a plurality of vehicle electrical connections located at the vehicle electrical interface end of the vehicle housing and configured to mate with the plurality of trailer electrical connections. The vehicle electrical connector further includes a vehicle-connector electrical cable attached to the vehicle electrical cable engagement end of the vehicle-connector housing. The preceding subject matter of this paragraph characterizes example 22 of the present disclosure.

The vehicle electrical connector further includes at least one vehicle-connector visibility light source coupled to the vehicle-connector housing. The preceding subject matter of this paragraph characterizes example 23 of the present disclosure, wherein example 23 also includes the subject matter according to example 22, above.

A length of the vehicle-connector housing extends in a first direction and the at least one vehicle visibility light source faces a second direction substantially perpendicular to the first direction. The preceding subject matter of this paragraph characterizes example 24 of the present disclosure, wherein example 24 also includes the subject matter according to example 23, above.

Additionally disclosed herein is a method that includes activating at least one visibility light source coupled to a trailer connector housing of a trailer electrical connector. The trailer connector housing includes a front section defining a trailer electrical interface end of the trailer connector housing and a rear section defining an electrical cable engagement end of the trailer connector housing and extending from the front section. The method also includes connecting a plurality of trailer electrical connections located at the trailer electrical interface end of the trailer connector housing to a plurality of vehicle electrical connections located at a vehicle electrical interface end of a vehicle connector housing of a vehicle electrical connector. The method further includes supplying electrical power to the plurality of trailer electrical connections and to the plurality of vehicle electrical connections via an electrical cable attached to the electrical cable engagement end of the trailer connector housing. The preceding subject matter of this paragraph characterizes example 25 of the present disclosure.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter of the present disclosure will be readily understood, a more particular description of the subject matter briefly described above will be rendered by reference to specific embodiments that are illustrated in the appended drawings. Understanding that these drawings depict only typical embodiments of the subject matter of the present disclosure and are not therefore to be considered to be limiting of its scope, the subject matter will be described and explained with additional specificity and detail through the use of the accompanying drawings, in which:

FIG. 1 is a top plan view of a trailer electrical connector, according to one or more examples of the present disclosure;

FIG. 2 is a bottom plan view of the trailer electrical connector of FIG. 1, according to one or more examples of the present disclosure;

FIG. 3 is a top plan view of a trailer electrical connector having a surface and handles with integrated visibility light sources, according to one or more examples of the present disclosure;

FIG. 4 is a bottom plan view of the trailer electrical connector of FIG. 3, according to one or more examples of the present disclosure;

FIG. 5 is a top plan view of a trailer electrical connector having handles with integrated visibility light sources, according to one or more examples of the present disclosure;

FIG. 6 is a bottom plan view of a trailer electrical connector having a switch, according to one or more examples of the present disclosure;

FIG. 7 is an isometric front view of a trailer electrical connector having visibility light sources at an electrical interface end, according to one or more examples of the present disclosure;

FIG. 8 is an isometric view of a trailer electrical connector, according to one or more examples of the present disclosure;

FIG. 9 is an isometric front view of a trailer electrical connector, according to one or more examples of the present disclosure;

FIG. 10 is a bottom plan view of a trailer electrical connector, according to one or more examples of the present disclosure;

FIG. 11 is an isometric side view of a trailer electrical connector having a visibility light source integrated on a receptacle, according to one or more examples of the present disclosure;

FIG. 12 is a top plan view of a vehicle electrical connector, according to one or more examples of the present disclosure;

FIG. 13 is a top plan view of a vehicle electrical connector having five electrical prongs, according to one or more examples of the present disclosure;

FIG. 14 is a top plan view of a vehicle electrical connector having a switch, according to one or more examples of the present disclosure;

FIG. 15 is a top plan view of a vehicle electrical connector having a switch and five electrical prongs, according to one or more examples of the present disclosure;

FIG. 16 is a bottom plan view of a trailer electrical connector with an integrated visibility light source, according to one or more examples of the present disclosure;

FIG. 17 is a top plan view of a trailer electrical connector having an integrated visibility light sources, according to one or more examples of the present disclosure;

FIG. 18 is an isometric view of a trailer electrical connector having a plurality of color indicators, according to one or more examples of the present disclosure;

FIG. 19 is an isometric view of a trailer electrical connector having a visibility light source integrated in the housing, according to one or more examples of the present disclosure;

FIG. 20 is an isometric view of a trailer electrical connector having handles with integrated visibility light sources facing towards an electrical interface end of the connector, according to one or more examples of the present disclosure;

FIG. 21A is a bottom plan view of a trailer electrical connector having a solar panel, according to one or more examples of the present disclosure;

FIG. 21B is a side view of an exploded portion of the trailer electrical connector of FIG. 21A, according to one or more examples of the present disclosure;

FIG. 22 is a bottom plan view of a trailer electrical connector having a mounting screw, according to one or more examples of the present disclosure;

FIG. 23A is an exploded top plan view of a trailer electrical connector, according to one or more examples of the present disclosure;

FIG. 23B is an exploded top plan view of a trailer electrical connector, according to one or more examples of the present disclosure;

FIG. 24 is a perspective view of a trailer electrical connector, according to one or more examples of the present disclosure;

FIG. 25 is an exploded top plan view of a trailer electrical connector, according to one or more examples of the present disclosure;

FIG. 26A is a perspective view of a removable portion of a trailer electrical connector, according to one or more examples of the present disclosure;

FIG. 26B is a side view of a removable portion of a trailer electrical connector, according to one or more examples of the present disclosure;

FIG. 26C is a back view of a removable portion of a trailer electrical connector, according to one or more examples of the present disclosure;

FIG. 27 is a side view of a trailer electrical connector, according to one or more examples of the present disclosure; and

FIG. 28 is a schematic flow chart diagram illustrating a method of using a trailer electrical connector, according to one or more examples of the present disclosure.

### DETAILED DESCRIPTION

Reference throughout this specification to “one example,” “an example,” or similar language means that a particular feature, structure, or characteristic described in connection with the example is included in at least one example of the subject matter of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more embodiments of the subject matter of the present disclosure, however, absent an express correlation to indicate otherwise, an implementation may be associated with one or more embodiments.

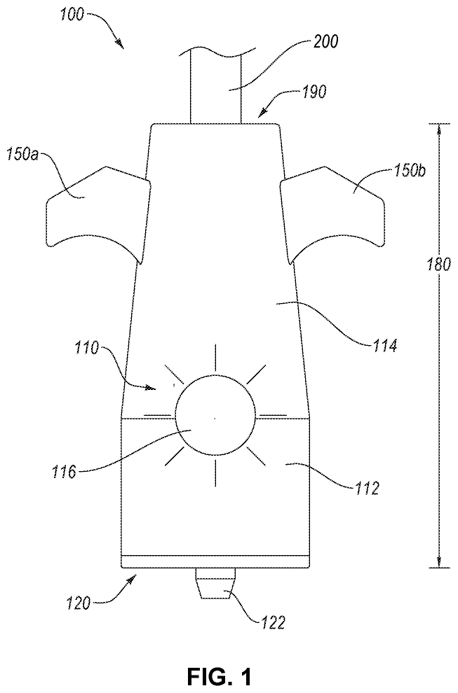

Referring to FIG. 1, in some examples, a trailer electrical connector 100 includes a housing 110, electrical connections 122, and an electrical cable 200. The housing 110 includes an interface end 120 and an electrical cable end 190. The interface end 120 is configured to mate with a vehicle electrical connector. Accordingly, in certain examples, the interface end 120 includes a pattern of engagement features 121a-g each configured to receive a corresponding one of a plurality of engagement features of the vehicle electrical connector, which are arranged in a pattern corresponding with that of the engagement features 121a-g. Referring to FIGS. 1 and 12-15, in some examples, the engagement features 121a-g are apertures, which are configured to receive prongs of the vehicle electrical connector 300 and/or of the vehicle electrical connector 400. However, in other examples, the engagement features 121a-g can be prongs configured to be inserted into corresponding apertures of the vehicle electrical connector. Referring back to FIG. 1, the electrical cable end 190 of the housing 110 is configured to receive and retain the electrical cable 200. The housing 110 has a length 180 that extends from the interface end 120 to the electrical cable end 190. The housing 110 can be portioned into a front section 112 and a rear section 114. The individual lengths of the front section 112 and the rear section 114 are combined to equal the overall length of the housing 110. The front section 112 includes and defines the interface end 120. The front section also includes the engagement features 121a-g and the electrical connections 122a-g. The front section 112 can be any length based on the configuration of the corresponding apertures of the vehicle electrical connector.

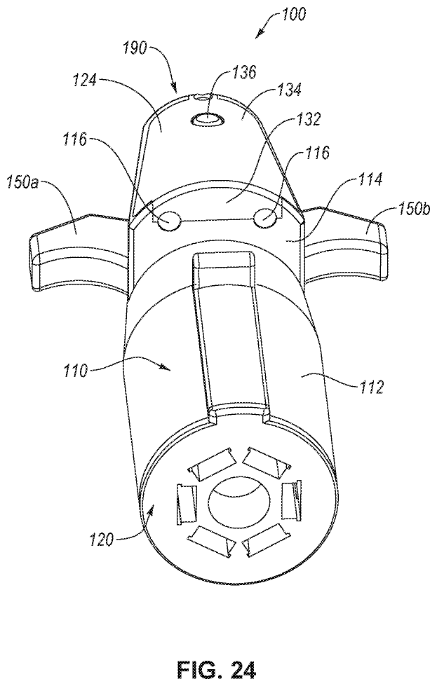

Referring to FIGS. 1-11, 21A, 22, 24, 25, and 27, in some examples, the rear section 114 defines and includes the electrical cable engagement end 190. In some examples, the rear section 114 is shaped to help provide strain relief for the electrical cable 200 and to reduce stress on internal electrical connections during handling, insertion, and removal of the trailer electrical connector 100. The rear section 114 can be further configured to enclose and protect internal components associated with the electrical cable 200, including electrical wiring, power sources, and circuitry, from environmental exposure.

Referring to FIGS. 1-11, in some examples, the front section 112 is cylindrical, or tubular, and the rear section 114 tapers from the front section 112 to the electrical cable end 190 where the housing 110 connects to the electrical cable 200. In some examples, the front section 112 has a constant outer dimension (e.g., diameter) along its length, and the rear section 114 has a variable outer dimension (e.g., diameter) along its length, such as one that decreases in a direction away from the front section 112. In certain examples, the rear section 114 has a circular cross-sectional shape, such that the rear section 114 has a conical shape. In other examples, the rear section 114 has flat faces that define a polygonal cross-sectional shape, such that the rear section has a pyramid shape. Accordingly, in certain examples, the front section 112 and/or the rear section 114 can have any of various cross-sectional shapes, other than circular, which can correspond with or not correspond with the cross-sectional shape of a receptacle of the vehicle electrical connector.

The rear section 114 includes extrusions 150a-b and the electrical cable end 190. In some examples, the extrusions 150a-b are handles by which the trailer electrical connector 100 is grippable. Referring to FIGS. 1-11, the housing can have multiple extrusions 150a-b (e.g., handles, wings, etc.). In some examples, the housing includes two extrusions 150a-b extending from opposing sides of the trailer electrical connector 100, such as from opposing sides of the rear section 114. The extrusions 150a-b extend generally perpendicularly away from an exterior surface of the rear section 114 (e.g., perpendicularly away from a central axis of the connector). These grip extrusions 150a-b are shaped in such a way to provide a user with an increased grip for removal and/or insertion of the trailer electrical connector. In the example shown in FIGS. 1-11, the extrusions 150a-b are shaped to form graspable wings on either side of the housing 110 to be grasped by a user during the disengagement and/or engagement of the trailer electrical connector 100 and the vehicle electrical connector. As shown, the extrusions 150a-b extend from the exterior surface of the tapering portion of the rear section 114 of the housing. In other examples, the extrusions 150a-b are located on, or form part of, the front section 112 and are closer to the interface end 120 of the connector. In another example, the extrusions 150a-b may consist of a series of ridges to increase the surface area gripped by the user. Referring to FIGS. 1-11, the extrusions 150a-b have a curved finger-gripping indentation which faces towards the interface end 120. Alternatively, the extrusions 150a-b can be circular having a large central hole in which a user may insert one or more fingers in order to grasp and remove the connector. In some examples, no extrusions are present, and intrusions or indentations may be gripped by the user.

The housing 110 houses and protects the electrical connections 122, which are coupled with the engagement features so that when the engagement features of the housing 110 are mated with the engagement features of the vehicle electrical connector, electrical connectors of the vehicle electrical connector contact and establish electrical connection with corresponding ones of the electrical connections 122. Each one of the electrical connections 122 is electrically connected with a corresponding one or more electrical wires of the electrical cable 200. In some examples, the housing 110 is a plastic. In some example, the housing 110 is manufactured by additive manufacturing. In another example, the housing 110 is plastic molded by one or more methods including injection molding, blow molding, thermoforming, or compression molding. The housing may be comprised of materials other than plastic.

Referring to FIGS. 1-11, 21A, and 22, in some examples, the electrical connections 122 are located at the electrical interface end 120 of the housing 110. In some examples, the electrical connections 122 are recessed within or substantially flush with the electrical interface end 120 to protect the electrical connections from damage and environmental exposure. Each of the electrical connections 122 is electrically coupled to a corresponding electrical conductor of the electrical cable 200 to transmit power and signaling between the towing vehicle and the trailer.

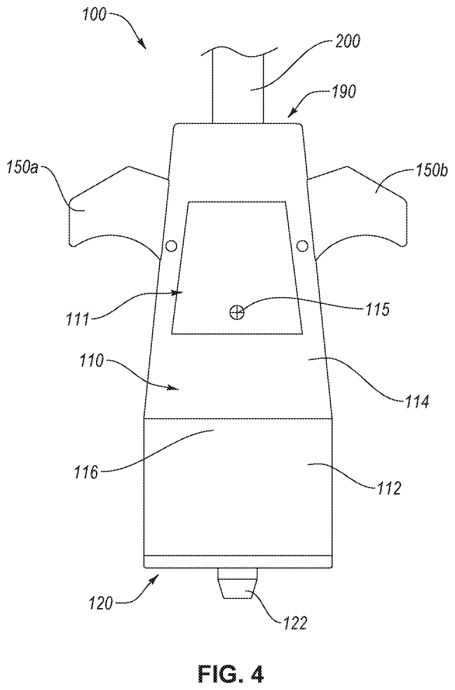

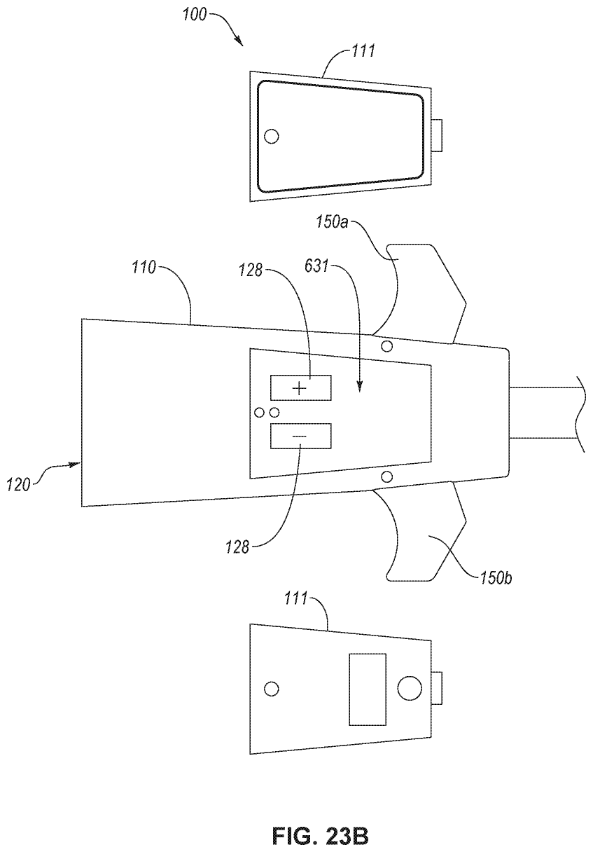

In some examples, the electrical connections 122 are configured to serve different functional roles depending on the connector configuration and intended use. For example, one or more electrical connections 122 can be configured as vehicle connections for transmitting vehicle lighting or signaling functions, such as brake lights, turn signals, or running lights, while one or more other electrical connections 122 can be configured as accessory connections for supplying electrical power to auxiliary trailer equipment. In some examples, one or more electrical connections are configured as safety connections, such as for braking, safety signaling, or other safety-related functions. In certain configurations, one or more electrical connection positions may be provided but not electrically coupled to a conductor, thereby defining dormant connections or blank connections that are unused, reserved for future use, or included to maintain compatibility with different vehicle or trailer connector standards. Referring to FIGS. 4, 6, 21A, 22, 23A, and 23B, in some examples, the housing 110 includes a selectively removable panel 111. For example, as shown in FIG. 4, the selectively removable panel 111 can be secured to the housing by a fastener 115, such as a screw. In another example, the selectively removable panel 111 is secured by a pull tab, or other securement mechanism. Referring to FIG. 21B, in some examples, the selectively removeable panel 111 includes a locking tongue 119 to prevent the non-fastened end of the panel 111 from disengaging with the housing 110 by fitting within a groove of the housing 110. In some examples, the selectively removable panel 111 includes a rubber grommet on the underside of the panel 111 to protect an internal circuit board and other internal wiring from external damage, such as water damage.

The trailer electrical connector 100 additionally includes at least one visibility light source 116 coupled to (e.g., attached to (primarily or secondarily), adhered to, formed in, etc.) the housing 110 or the electrical cable 200. The visibility light source 116 can be any of various types of light sources that generate and emit visible light with an intensity sufficient to provide illumination in low ambient lighting conditions. Some examples of a visibility light source 116 include, but are not limited to, a light emitting diode (LED), a high-intensity discharge (HID) bulb, a laser, a conventional filament bulb, a quantum dot light source, an organic LED (OLED), a microLED, a laser-based light source, a nanowire LED, an incandescent bulb, or a combination thereof.

In some examples, the at least one visibility light source 116 is permanently attached to the trailer electrical connector 100, such as by being molded into or integrally formed with the housing 110. In other examples, the visibility light source 116 is semi-permanently attached, such as by being secured to the housing 110 using one or more fasteners or capture features that permit removal with tools. In still other examples, the visibility light source 116 is non-permanently attached, such as by a magnet, latch, snap-fit, or other detachable coupling mechanism. In each such example, the trailer electrical connector 100 defines an intended storage location for the visibility light source 116 and remains the primary and prominent location at which the visibility light source 116 is stored and used over time.

As used herein, in addition to one or more light generating devices, the visibility light source 116 can also include other components necessary for operation, protection, and/or coupling of the light generating devices to the housing 110. For example, the visibility light source 116 can include any covering or protection layers necessary to protect the light generating devices from external damage. Also, in some examples, the visibility light source 116 can include circuitry (e.g., circuit board and electrical circuit components) for operation of the visibility light source 116.

The size of the visibility light source 116 can vary based on the location of the visibility light source 116 and type of light source. Additionally, as used herein, each visibility light source 116 can include at least one light generating device. For example, the visibility light source 116 can include a cluster or grouping of multiple light generating devices (e.g., a cluster of LEDs). Moreover, in examples where the visibility light source 116 includes multiple light generating devices, at least one of the light generating devices can be different than another one of the light generating devices.

The light generated and emitted by the visibility light source 116 can be defined according to an intensity and wavelength of the light. Generally, the light is visible light and has a wavelength within the visible light spectrum. Additionally, as presented above, the light has an intensity sufficient to illuminate a space in which low ambient lighting conditions exist. Accordingly, as defined herein, the light generated and emitted by the visibility light source 116 has an intensity of at least 20 lumens. Accordingly, the intensity of the light generated and emitted by the visibility light source 116 is greater than the intensity of light associated with power indicator lights, which are typically between 0.5 and 5 lumens and not intense enough to sufficiently illuminate spaces with low ambient lighting conditions. In some examples, the visibility light source 116 generates light at an intensity between, and inclusive of, 20-5,000 lumens. According to one particular example, the light generated by the visibility light source 116 has an intensity between, and inclusive of 20 and 200 lumens. In another example, the intensity of the generated light is between, and inclusive of, 200 and 1000 lumens. In yet another example, the intensity of the generated light is between, and inclusive of, 1,000-5,000 lumens.

Referring FIG. 1, in some examples, the trailer electrical connector 100 includes one visibility light source 116. In the illustrated example of FIG. 1, the single visibility light source 116 is located on a top surface of the housing 110 between the interface end 120 and the electrical cable end 190 (e.g., overlaps with a transition from the front section and the rear section 114).

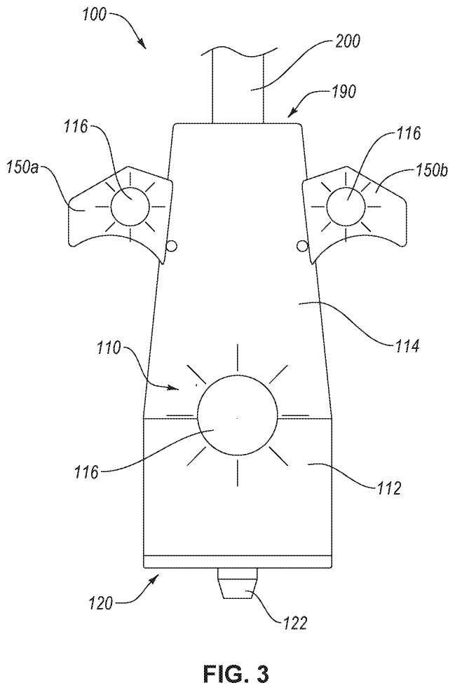

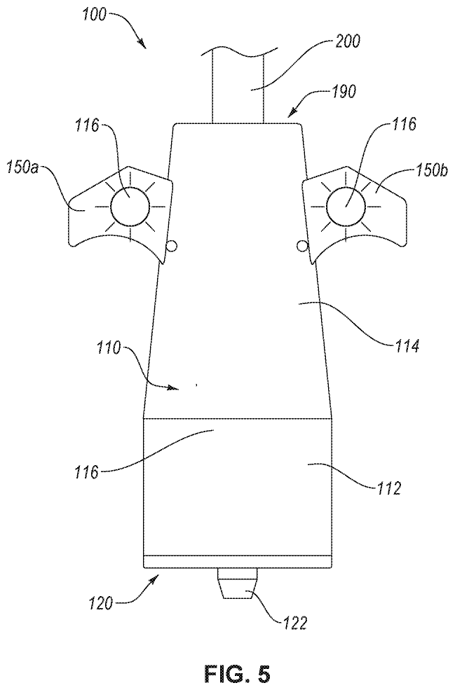

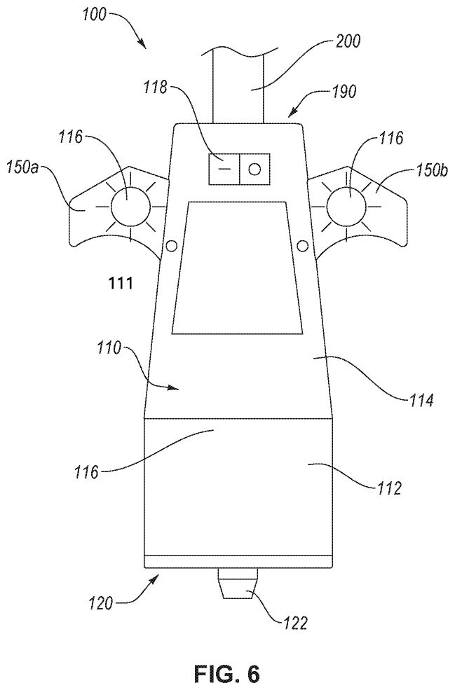

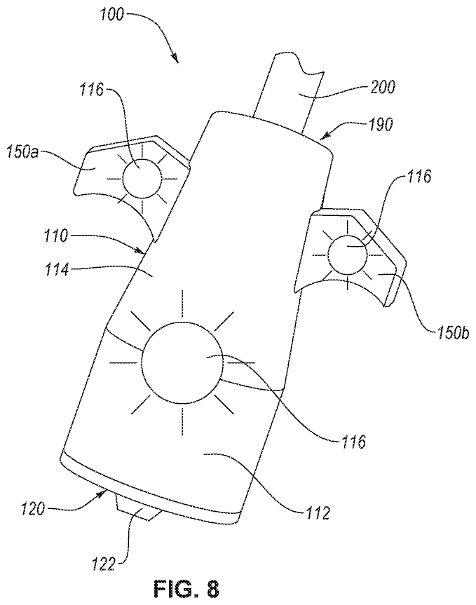

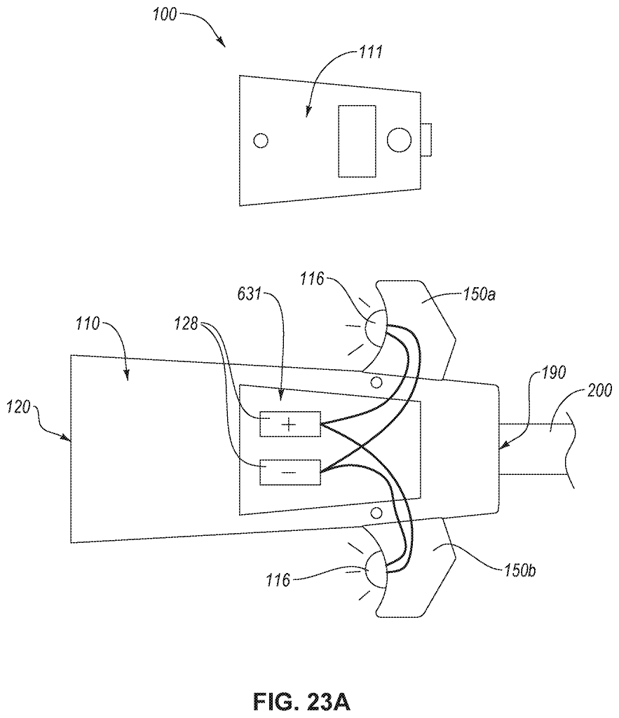

In contrast to FIG. 1, referring to FIGS. 3, 5-8, 10, 11, 16-18, 20, 22-25 , and 26A-C, in some examples, the trailer electrical connector 100 includes multiple visibility light sources 116. In some examples, the visibility light sources 116 can be uniform in size. In another example, the visibility light sources 116 may vary in size based on location within the housing. In some examples, the light sources 116 may produce visible light of one or more colors. In some examples, the light sources 116 may alternate between one or more colors of light. In the illustrated example of FIGS. 3 and 8, one of the visibility light sources 116 is located on the top surface of the housing 110 and the other ones of the visibility light sources 116 are located on the top surface of respective ones of the extrusions 150a-b. Referring to FIG. 5, in an alternative example, the visibility light sources 116 are located on the top surface of only the extrusions 150a-b. Referring to FIG. 6, in some examples, the visibility light sources 116 are located on the bottom surface of each of the extrusions 150a-b. The visibility light sources 116 of FIGS. 1, 3, 5, 6, and 8, being in a top-facing or bottom-facing arrangement, are configured to illuminate the space above or below, respectively, the trailer electrical connector 100.

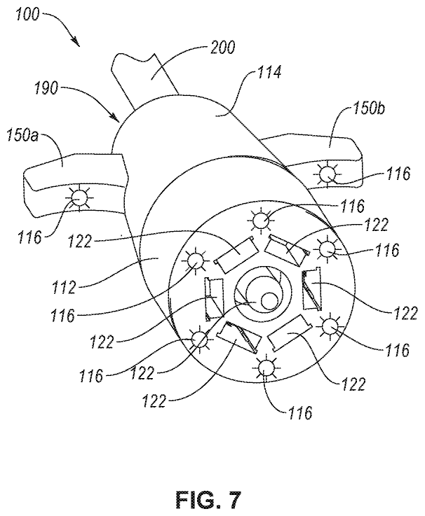

Referring to FIG. 7, in yet another example, the visibility light sources 116 are forward facing and located in forward facing surfaces of the housing 110. According to one example, one visibility light source 116 is in a forward-facing surface of each of the extrusions 150a-b and/or multiple visibility light sources 116 are located on the interface end 120 of the trailer electrical connector 100. In some examples, the visibility light sources 116 face the electrical connections 122a-g to illuminate the electrical connections 122a-g. The visibility light sources 116 in the interface end 120 can be arranged in a circular arrangement about the electrical connections 122a-g. The visibility light sources 116 of FIG. 7, being in a forward-facing arrangement, are configured to illuminate the space in front of the trailer electrical connector 100.

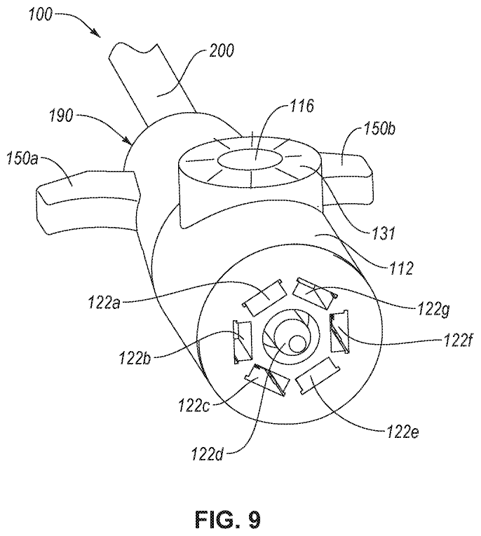

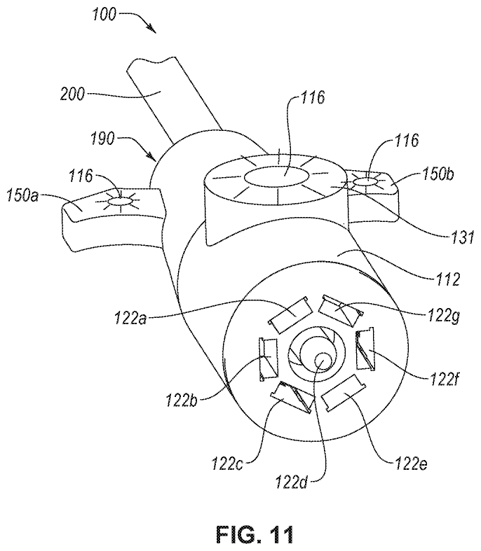

Referring to FIGS. 9 and 11, the housing 110 may include a receptacle 131 shaped to hold one or more visibility light sources 116. The receptacle 131 can be shaped and sized based on the shape and size of the one or more visibility light sources 116. In some examples, the receptacle 131 and the at least one visibility light source 116 are circular shapes, such as shown in FIGS. 9 and 11. However, in other examples, the receptacle 131 and the visibility light source 116 are polygonal shaped (e.g., rectangular or square shaped). The location of the receptacle 131 can vary based on the shape of the housing 110 and the configuration of the electrical engagement features. In the examples shown in FIGS. 9 and 11, the receptacle 131 is located near the midpoint of the housing length 180. The receptacle 131 is further located approximately equidistantly between the extrusions 150a and 150b on the back section of the housing 110.

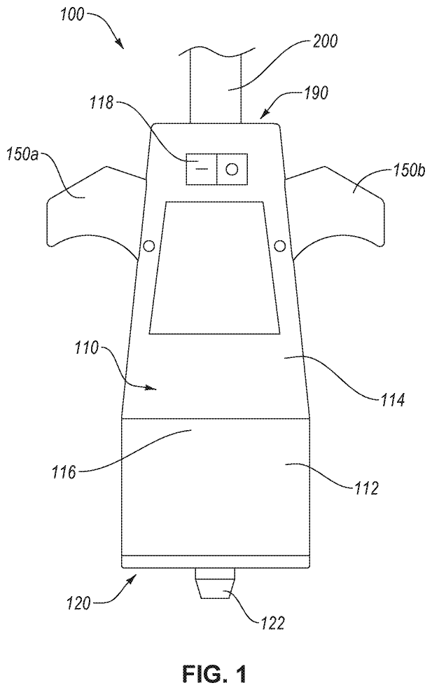

Referring to FIGS. 2, 6, and 10, in some examples, the visibility light source 116 is (or visibility light sources are) selectively powered on and off by a switch 118 of the trailer electrical connector 100. In some examples, the switch 118 is operable to selectively activate the at least one visibility light source 116 when no power is supplied to the plurality of electrical connections 122a-g. In such examples, the switch 118 is operable to selectively activate another power source integrated into the trailer electrical connector 100, such as a battery that powers the visibility light source 116. The switch 118 can be any of various types of manually-operated switches, such as a toggle switch as shown in FIGS. 2, 6, and 10, a push button switch as shown in FIGS. 21-25, a slide switch, or any switch facilitating an on and off setting. In some examples, the switch 118 includes at least one of a rocker, a momentary contact switch, a photocell, or a passive infrared (PIR) sensor. According to some examples, the switch 118 is located on or within the housing 110. In some examples, the switch 118 can include at least one of a light-sensing element or a motion-sensing element configured to automatically activate the visibility light source 116 in response to at least one of a detected ambient light level or a detected motion.

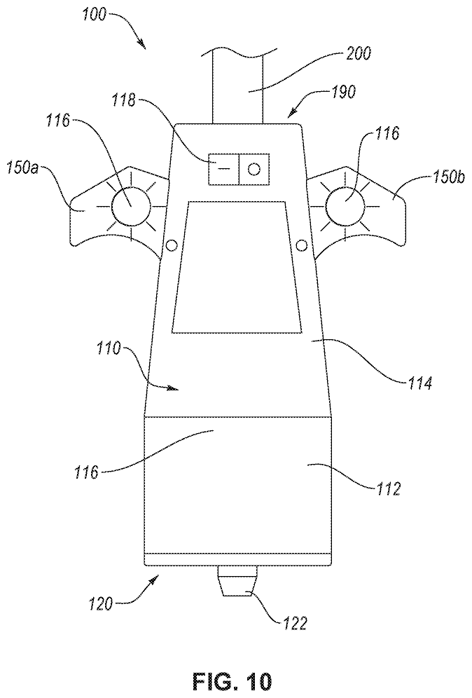

Referring to FIG. 10, in some examples, the switch 118 is on the same side of the housing 110 as the visibility light source 116. Moreover, referring to FIGS. 2, 6, and 10, the switch 118 can be located on the rear portion 114 closer to the electrical cable end 190 of the housing 110. Referring to FIGS. 1-2, the switch 118 can be located on the side of the housing 110 that is opposite the visibility light source 116. In some examples, the switch 118 is not located on the housing 110 but is instead located on an exterior device and operates the visibility light source 116 via remote control.

In some examples, the visibility light source 116 utilizes power received from the electrical cable 200 to generate light. For example, the visibility light source 116 can be powered by electrical power supplied from the trailer (e.g., trailer battery, trailer solar power, trailer generator, etc.).

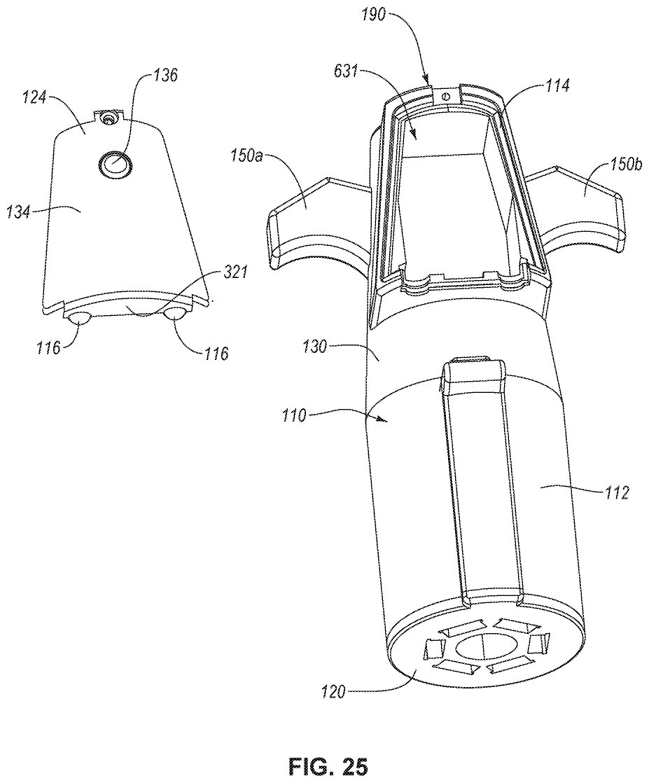

In other examples, the trailer electrical connector 100 provides the power for the visibility light source 116 to generate light. Accordingly, in these examples, the visibility light source 116 is powered independently of the trailer. For example, the trailer electrical connector 100 can include one or more power supplies 804, such as batteries, which can be housed by the housing 110. In some examples, the batteries are accessible via a selectively removable panel 111 of the housing 110, as illustrated by FIGS. 21A-B and FIGS. 23A-B. Therefore, in certain examples, the power supplies 804 can be non-rechargeable batteries that are replaced when depleted. However, in other examples, the power supplies 804 can be rechargeable batteries. Referring to FIGS. 21-22 and 23A-B, in some examples, the trailer electrical connector 100 includes a small solar panel 117 coupled to the housing 110. The solar panel 117 is configured to collect solar power and convert it into electrical power, which can be stored in the rechargeable power supplies 804 housed by the housing 110. In other examples, the rechargeable power supplies 804 are recharged by a vehicle, such as a towing vehicle, when the trailer electrical connector 100 is connected to the vehicle. In some examples, the rechargeable power supplies 804 are recharged by a battery external to the trailer electrical connector 100, such as a battery of a trailer to which the trailer electrical connector 100 is connected. In yet another example, the rechargeable power supplies 804 can be recharged by a different external power source, such as via a plug-in adapter.

In some examples, in addition to providing illuminating light, the visibility light source 116 can also be illuminated to indicate a proper connection when the trailer electrical connector 100 is connected to a vehicle. In other words, the visibility light source 116 can be powered when the trailer electrical connector 100 is properly connected to the corresponding vehicle electrical connector. The trailer electrical connector 100 can be configured so that the visibility light source 116 generates light at a lower intensity or different wavelength (e.g., color versus white light) to show connection status than when providing illuminating light. The connection status is a connection status between the trailer electrical connector 100 and the corresponding vehicle electrical connector.

In some examples, the visibility light source 116 is operable in multiple different selectable modes. For example, a selectable mode for the visibility light source 116 can include at least one of: a high-intensity mode, a low-intensity mode, a strobe mode, an SOS signaling mode, a beacon mode, or an adjustable-focus mode. In some examples, the selectable modes are implemented by controlling electrical power supplied to the visibility light source 116, including at least one of current, voltage, duty cycle, pulse width, or signal frequency. In such examples, the selectable modes may be use-selectable via the switch 118 or may be automatically selected by one or more electronic components, such as a controller or circuit, based on predefined conditions or inputs. In some examples, the strobe mode, SOS signaling mode, or beacon mode includes intermittently energizing the visibility light source 116 according to a predetermined timing pattern. In some examples, the adjustable-focus mode includes altering a light output characteristic of the visibility light source 116 using one or more optical elements, lenses, diffusers, or light-directing structures, or by selectively activating one or more light-emitting elements. The selectable modes can be used individually or in combination and can be configured to help enhance visibility, signaling, or illumination in low-ambient-light conditions.

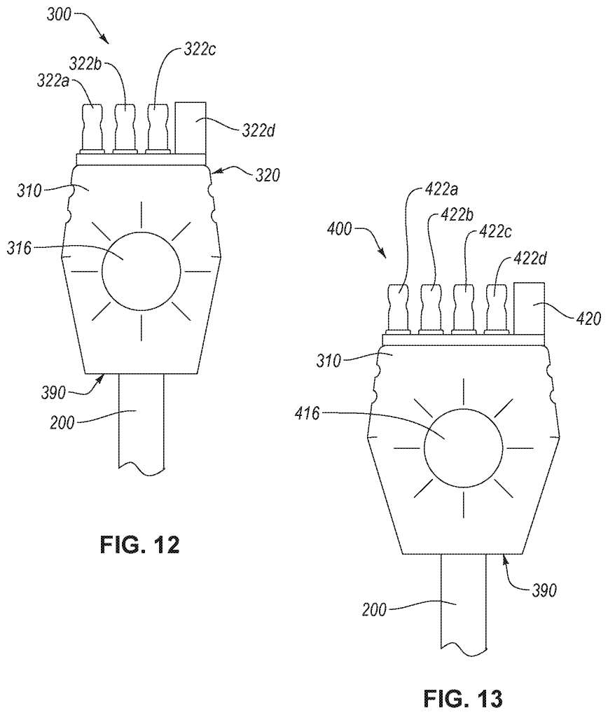

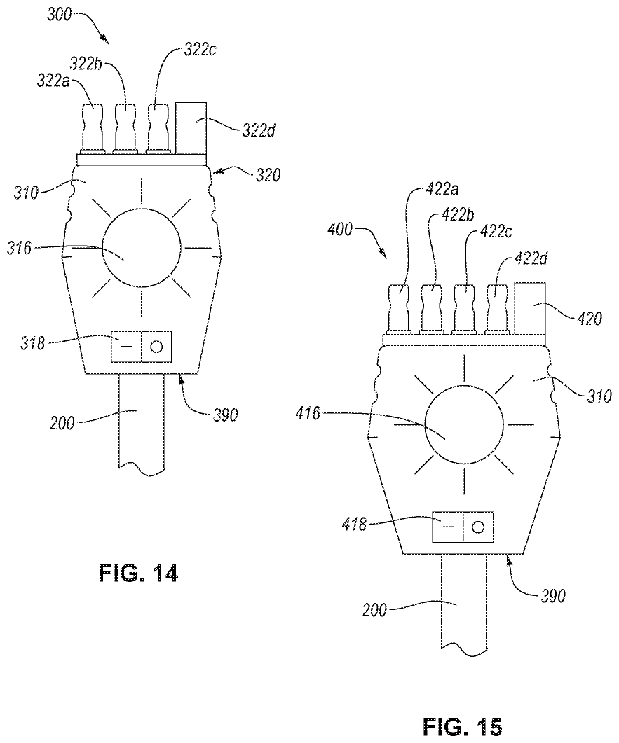

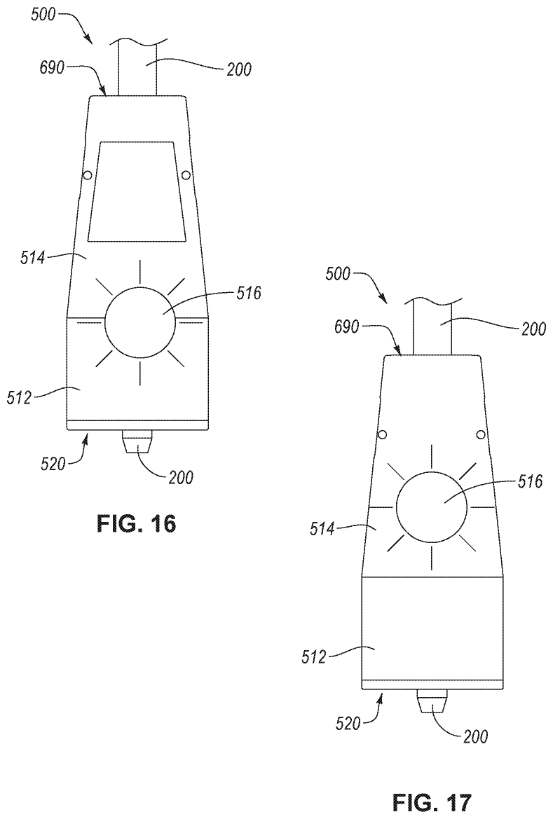

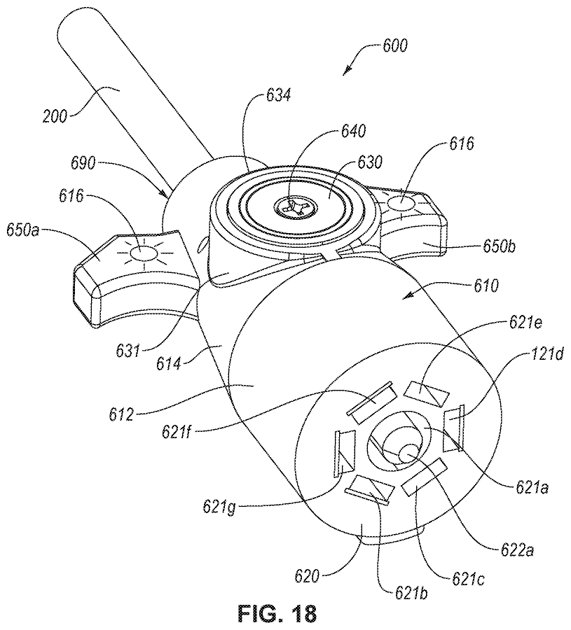

Referring to FIGS. 1-11 and 16-20, according to some examples, the interface end 120 of the trailer electrical connector 100 is adapted to receive a 7-prong vehicle connector. In such examples, the housing has a generally circular-shaped cross-section. In another example, as shown in FIGS. 12 and 14, the interface end 320 is adapted to mate with a 4-prong vehicle connector 300. In another example, as shown in FIGS. 13 and 15, the interface end 420 is adapted to mate with a 5-prong vehicle connector 400. In these latter two examples, the housing has a flatter shape or non-round cross-sectional shape, such as a rectangular-shaped cross-section. In some examples, each of the 4-prong vehicle connector 300 and the 5-prong vehicle connector 400 includes a housing 310 having a vehicle electrical interface end 320 or 420 and a vehicle electrical cable engagement end 390. A vehicle-connector electrical cable 200 is attached to the vehicle electrical cable engagement end 190 of the vehicle-connector housing 310.

Despite being shaped differently, the 4-prong and 5-prong vehicle connectors include light sources 316 and 416 respectively. In some examples, the light sources 316 and 416 are vehicle-connector visibility light sources that are coupled to the vehicle-connector housing 310. In some examples, the vehicle-connector housing 310 extends in a first direction, and the at least one vehicle visibility light source 316, 416 faces a second direction that is substantially perpendicular to that first direction (e.g., away from the length of the vehicle-connector housing 310). Additionally, the 4-prong connector 300 includes an interface end 320 having electrical connections 322a-d. Similarly, the 5-prong connector 400 includes an interface end 420 and electrical connections 422a-e. Additional features of the electrical connectors 300 and 400 may be the same as those of the trailer electrical connector 100, with like features having like numbers, but in a different series. For example, although the illustrated implementations of the connectors 300 and 400 do not have wings, in other implementations, the connectors 300 and 400 can have wings. Also, although the illustrated implementations of the connectors 300 and 400 do not show a magnet, in these and other implementations, the connectors 300 and 400 can have one or more magnets on the same side as the light source or the opposite side.

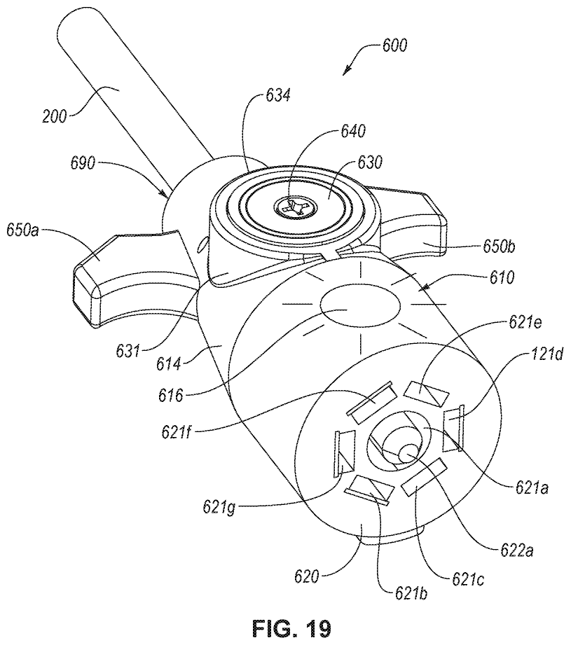

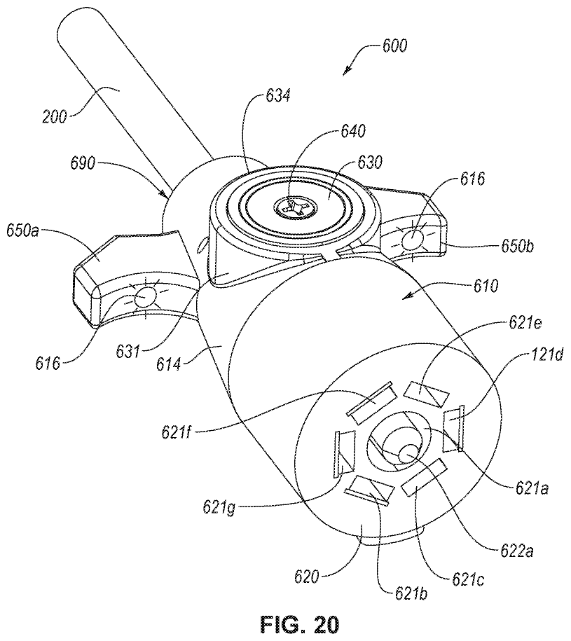

FIGS. 16-17 illustrate another example of a trailer electrical connector 500 of the present disclosure. The trailer electrical connector 500 is similar to the trailer electrical connector 100 except trailer electrical connector 500 does not include extrusions or handles. The trailer electrical connector 500 includes a housing 510, a first portion 512, a second portion 514, an interface end 520, an electrical cable end 590, and an electrical cable 200, similar to the trailer electrical connector 100. More specifically, the features of the trailer electrical connector 500 directly correspond to the features of the trailer electrical connector 100 having like numbers, but in a different series. Accordingly, unless otherwise noted, the features of the trailer electrical connector 500 and the housing 510 are the same as or similar to the corresponding features of the trailer electrical connector 100 and the housing 110.

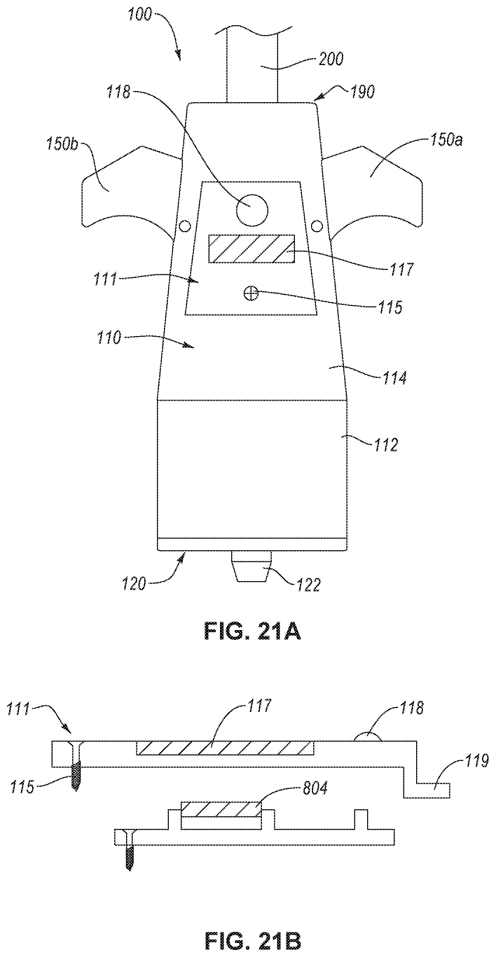

FIGS. 18-20 illustrate another example of a trailer electrical connector 600 of the present disclosure. The trailer electrical connector 600 is similar to the trailer electrical connector 100 except the trailer electrical connector 600 includes a magnet 630 in addition to the light source 116. The trailer electrical connector 600 includes a housing 610, an interface end 620, an electrical cable end 690, and an electrical cable 200, similar to the trailer electrical connector 100. More specifically, the features of the trailer electrical connector 600 directly correspond to the features of the trailer electrical connector 100 having like numbers, but in a different series. Accordingly, unless otherwise noted, the features of the trailer electrical connector 600 and the housing 610 are the same as or similar to the corresponding features of the trailer electrical connector 100 and housing 110.

In some examples, the housing 610 further includes a magnet 630. The rear section 614 includes a receptacle 631 for the magnet, extrusions 650a-b, and the electrical cable end 690. The rear section may vary in length depending on the magnet receptacle 631 and the extrusions 650a-b.

Referring to FIGS. 18-20, in some examples, extrusions 650a-b have an external planar face which is parallel to the mounting surface of the magnet 630. These grip extrusions 650a-b are shaped in such a way to provide a user with an increased grip for removal and/or insertion of the trailer electrical connector.

In some examples, the housing 610 additionally includes a receptacle 631 shaped to hold the magnet 630. The receptacle 631 may vary in shape and size based on the shape and size of the magnet 630. For example, the receptacle 631 and the magnet 630 can be circular shaped, such as shown in FIGS. 18-20. However, in other examples, the receptacle 631 and the magnet 630 are polygonal shaped (e.g., rectangular or square. The location of magnet receptacle 631 will vary based on housing 610 shape and electrical engagement features. In the example shown in FIGS. 18-20, the magnet receptacle 631 is located near the midpoint of the housing length. The magnet receptacle 631 is further located in approximately equidistance between the extrusions 650a and 650b on the back section of the housing 610. The central location will assist a user in providing equal force on the electrical connector 600 when disengaging from storage or removing from the corresponding vehicle connector.

Referring to FIGS. 18-20, in some examples, the magnet 630 is seated within the magnet receptacle 631 so that a mounting surface of the magnet 630 is exposed and faces away from the housing 610. In some examples, as shown FIGS. 18-20, the magnet receptacle 631 is defined within a boss protruding from an exterior surface of the back section of the housing 610. As shown in FIGS. 18-20, the magnet receptacle 631 extends from the tapering portion of the rear section 614 of the connector. In some examples, the magnet receptacle 631 extends from the tapered portion having a height such that an outer rim of the magnet receptacle 631 is substantially flush with an exterior surface of the front section 612 of the housing 610 of the connector. In some examples, the magnet 630 extends past the magnet receptacle 631 so that a mounting surface (i.e., exposed surface) of the magnet 630, which is parallel to the central axis of the connector, is proud of the outer rim. In other examples, the mounting surface of the magnet 630 is flush with the magnet receptacle 631 and the outer rim. The mounting surface is configured to magnetically attach to a metal portion of a trailer frame corresponding with the electrical connector 600. In another example, the mounting surface magnetically engages a magnet, formed in or attached to the trailer, which has an opposite polar charge of the mounting surface of the magnet 630. The polar opposite connection increases the strength of the magnetic connection between the trailer electrical connection 600 and the trailer frame so that the electrical connector 600 cannot be accidentally disengaged from a storage location.

In some examples, the magnet 630 is attached to the housing 610 at least partially within the receptacle 631 using any of various methods. For example, the receptacle 631 can have a layer of insulating material 634 to lessen the magnetic field of the magnet 630 within an internal cavity of the housing 610. The magnet 630 can be fastened to the receptacle by at least one of the following: a screw 640, nail, or rivet. In an alternative example, the magnet 630 can be attached by a chemical bonding or adhesion techniques, such as via an adhesive or glue. In another example, the magnet 630 can be retained in place in the housing as the housing is molded during a molding process. In yet another example, the magnet 630 is selectively secured within the receptacle 631 by at least one resiliently flexible tab or rib formed in or around the receptacle 631.

In some examples, the magnet 630 is attached to the housing 610 within the receptacle 631 by a screw 640. The screw 640 can be unfastened to remove the magnet 630 from the housing 610 and the receptacle 631. The magnet 630 can then be interchanged with another magnet or be inserted back into the receptacle 631. The magnet may be removed for a number of reasons such as: to change the strength of the magnet; to replace a damaged magnet; to clean the magnet; and to clean the receptacle, to name a few.

In another example, as mentioned, the magnet 630 is secured within the receptacle 631 by at least one tab or rib. The tab can have a resiliently flexible portion that resiliently flexes to insert the magnet 630 into and returns to its original shape to retain the magnet 630 within the receptacle 631. The tab or rib can resiliently flex when the magnet is being removed and return to its original shape when the magnet is removed. The housing 610 can include a single tab or rib that partially overs the receptacle 631. In yet some examples, the housing 610 has a series of tabs arranged along the outer edge of the receptacle 631. As mentioned, whether a single tab or rib, or multiple tabs or ribs, the tab(s) or rib(s) help to removably secure the magnet 630 and enable selective removal of the magnet 630 for replacement or cleaning.

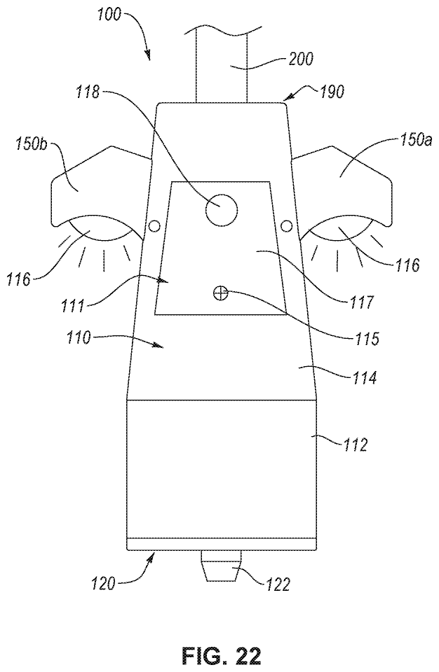

Referring to FIG. 18, in some examples, the visibility light sources 616 are located in the extrusions 650a-b, and can be oriented parallel to the magnet 630 so that they emit light in the same general direction that the magnet 630 faces. In another example, as shown in FIG. 19, the visibility light source 616 is located on the front portion 612 of the housing 610 and faces in the same general direction as the magnet 630. In yet another example, the visibility light sources 616 face forward (or a direction substantially perpendicular to the direction the magnet 630 faces and/or substantially perpendicular to the interface end 620) and are located within the extrusions 650a-b (as shown) and/or in the interface end 620 but do not interfere with the engagement features 621a-g. In some examples, at least one of the visibility light sources 116 is located within the housing 110 on the same side of the housing 110 as the magnet 630. In some examples, at least one of the visibility light sources 116 is located within the housing 110 on an opposite side of the housing 110 as the magnet 630.

The trailer electrical connectors disclosed herein, having at least one visibility light source 116, can effectively be used as a flashlight by a user in low light situations. However, because the trailer electrical connectors are always tethered to the trailer, unlike a portable flashlight, a user will always be able to locate and use the trailer electrical connector as a flashlight when needed without looking for or remembering to bring a flashlight. The trailer electrical connector can be used generally as a flashlight for whatever activity requires light in low light conditions, and more specifically to more easily locate and connect the trailer electrical connector to a vehicle connector (e.g., receptacle).

Referring to FIGS. 23A-23B, the trailer electrical connector 100 includes a removable back panel 111. In some examples, the removable back panel 111 includes a hole and corresponding mounting screw 115, a solar panel 117, a push button switch 118, and a locking tongue 119. The removable back panel 111 may cover the positive and negative power terminals 128 of the light source 116 and/or of the power supply, as well as a circuit board, not shown, supporting the internal electrical components. The removable back panel 111 may include a locking tongue 119. The locking tongue 119 couples to an insert within the housing 110. In some examples, the removable back panel 111 does not include a locking tongue 119. In some examples, the removable back panel 111 includes multiple holes and mounting screws 115. The mounting screws 115 couple the removable back panel 111 to the housing 110. The holes for the mounting screws 115 can be predrilled to accommodate the mounting screws 115. In another example, the mounting screws 115 are self-tapping and will cut the housing 110 as the screws 115 are tightened. In yet another example, the mounting screws 115 are self-tapping and cut into prefabricated holes of the housing 110.

Referring to FIG. 23B, in some examples, the removable back panel 111 includes a second side 111a of the removable back panel 111. For example, the second side 111a can include a rubber or waterproof gasket. In some examples, the rubber or waterproof gasket is secured within a channel of the second side. In other examples, the rubber or waterproof gasket is co-manufactured with the removable back panel 111.

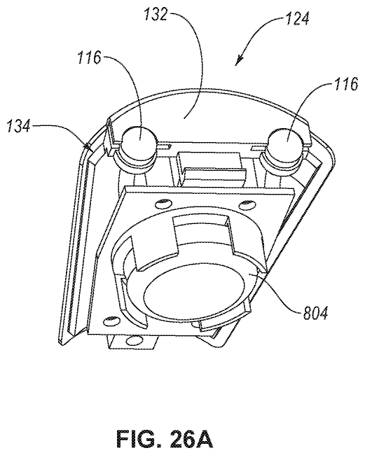

Referring to FIG. 24, in some examples, the multiple visibility light sources 116 are located on the housing 110 between the two extrusions 150a and 150b.

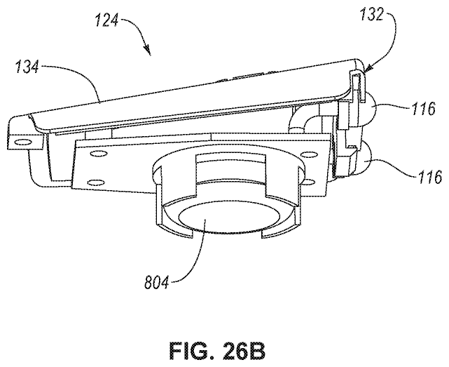

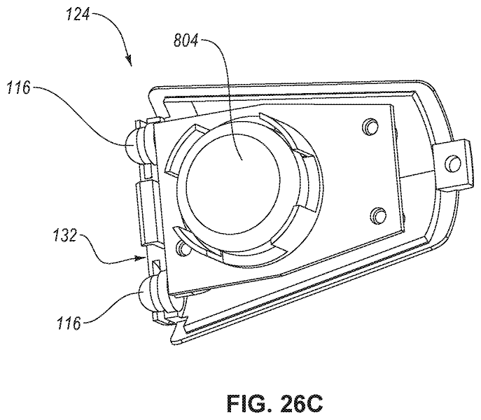

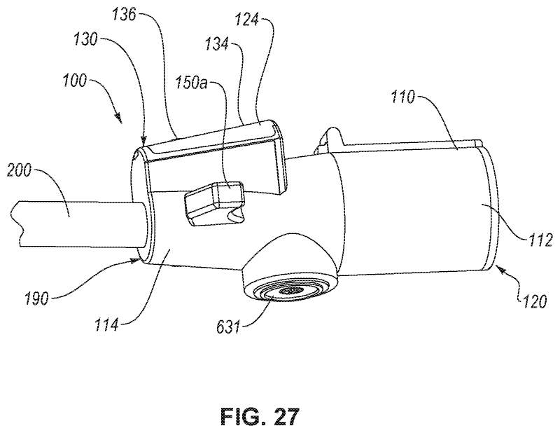

Referring to FIG. 25, in some examples, the housing 110 includes a receptacle 631, which can be a power supply receptacle and/or a magnet receptacle. The receptacle 631 is formed in an external surface 130 of the housing 110. Referring to FIGS. 26-31, in some examples, the housing 110 includes a cover 124 that is removably received by the external surface 130 to be substantially flush with the external surface 130 and to cover the receptacle 631. Referring to FIG. 27, in some examples, the cover 124 covers a first receptacle that houses the power supply, and the housing 110 includes another receptacle 631 on the opposite side that houses a magnet.

In some examples, at least one of the visibility light sources 116 is within and attached to the cover 124. For example, referring to FIGS. 25 and 26A-C, in some examples, the cover 124 includes a first cover surface 132 extending in a first direction that is substantially perpendicular to a length of the housing 110. At least one visibility light source is coupled to the housing 110 at and located within the first external surface 130. In some examples, the first cover surface 132 is substantially parallel to the electrical interface end 120. The cover 124 also includes a second cover surface 134 extending in a second direction that is different than the first direction. In some examples, the second direction is substantially parallel to a length of the housing 110.

Referring to FIGS. 24, 25, and 27, in some examples, the housing 110 includes a button 136 that is operable to remove the cover 124 from the external surface 130, providing access to the receptacle 631. In some examples, the button 136 is located on the second cover surface 134. The cover 124, the visibility light source 116, and a power supply can collectively form a modular light source device that can be handled and used separately from the housing 110. Accordingly, in such examples, the visibility light source 116 can be used for any of various uses other than electrically connecting the trailer electrical connector 100, such as uses remote from the trailer electrical connector 100. The visibility light source 116 can then be reattached to the housing 110 so that it co-movable with the housing 110, which is useful when electrically connecting the electrical connector to a vehicle.

Referring to FIGS. 26A-C, in some examples, the trailer electrical connector includes a power supply 804. According to one or more examples, the power supply 804 supplies power to at least one of the visibility light sources 116. For example, the power supply can be a rechargeable battery. The power supply 804 is attached to the cover 124 such that the power supply 804 is received by the receptacle 631 when the cover 124 is received by the external surface 130.

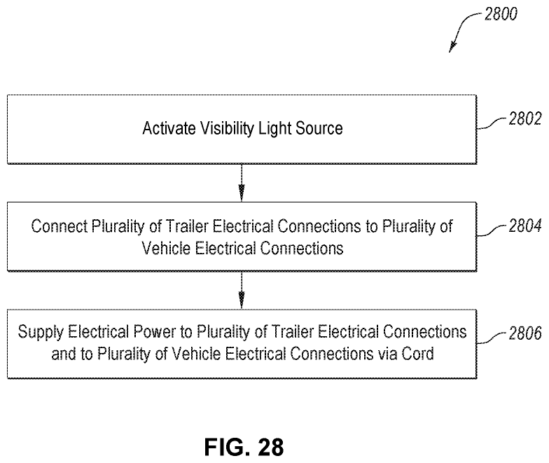

Referring to FIG. 28, a method 2800 of operating a trailer electrical connector 100 includes activating (block 2802) at least one visibility light source coupled to a trailer connector housing of a trailer electrical connector. The trailer connector housing includes a front section defining a trailer electrical interface end of the trailer connector housing and a rear section defining an electrical cable engagement end of the trailer connector housing and extending from the front section. The method 2800 also includes connecting (block 2804) a plurality of trailer electrical connections located at the trailer electrical interface end of the trailer connector housing to a plurality of vehicle electrical connections located at a vehicle electrical interface end of a vehicle connector housing of a vehicle electrical connector. The method 2800 includes supplying (block 2806) electrical power to the plurality of trailer electrical connections and to the plurality of vehicle electrical connections via an electrical cable attached to the electrical cable engagement end of the trailer connector housing.

In the above description, certain terms may be used such as “receiving,” “inserting,” “attaching,” “connecting,” and the like. These terms are used, where applicable, to provide some clarity of relationships. But, these terms are not intended to imply absolute relations. Rather, these terms may be interchangeable with one another.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

The term “about” or “substantially” or “approximately” in some embodiments, is defined to mean within +/−5% of a given value, however in additional embodiments any disclosure of “about” or “substantially” or “approximately” may be further narrowed and claimed to mean within +/−4% of a given value, within +/−3% of a given value, within +/−2% of a given value, within +/−1% of a given value, or the exact given value. Further, when at least two values of a variable are disclosed, such disclosure is specifically intended to include the range between the two values regardless of whether they are disclosed with respect to separate embodiments or examples, and specifically intended to include the range of at least the smaller of the two values and/or no more than the larger of the two values. Additionally, when at least three values of a variable are disclosed, such disclosure is specifically intended to include the range between any two of the values regardless of whether they are disclosed with respect to separate embodiments or examples, and specifically intended to include the range of at least the A value and/or no more than the B value, where A may be any of the disclosed values other than the largest disclosed value, and B may be any of the disclosed values other than the smallest disclosed value.

The subject matter of the present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A trailer electrical connector comprising:
a housing comprising:
a front section defining an electrical interface end of the housing; and
a rear section defining an electrical cable engagement end of the housing and extending from the front section;
at least one visibility light source coupled to the housing;
a plurality of electrical connections located at the electrical interface end of the housing; and
an electrical cable attached to the electrical cable engagement end of the housing.

2. The trailer electrical connector of claim 1, wherein the at least one visibility light source comprises at least one of a light emitting diode (LED), a quantum dot light source, an organic LED (OLED), a microLED, a laser-based light source, a nanowire LED, a high-intensity discharge (HID) bulb, or an incandescent bulb.

3. The trailer electrical connector of claim 1, further comprising a switch that selectively powers the at least one visibility light source, wherein the switch comprises at least one of a push button, a toggle, a rocker, a slide switch, a momentary contact switch, a photocell, or a passive infrared (PIR) sensor.

4. The trailer electrical connector of claim 3, wherein the switch comprises at least one of a light-sensing element or a motion-sensing element configured to automatically activate the at least one visibility light source in response to at least one of a detected ambient light level or a detected motion.

5. The trailer electrical connector of claim 1, wherein the at least one visibility light source generates light at an intensity of at least 20 lumens.

6. The trailer electrical connector of claim 1, wherein:
the housing further comprises at least two handles located on opposing sides of the trailer electrical connector;
the at least one visibility light source comprises multiple visibility light sources; and
the multiple visibility light sources are located between the at least two handles.

7. The trailer electrical connector of claim 1, wherein the at least one visibility light source is located on the electrical interface end of the housing.

8. The trailer electrical connector of claim 7, wherein the at least one visibility light source is oriented to face a direction substantially perpendicular to the electrical interface end of the housing.

9. The trailer electrical connector of claim 1, wherein:
the housing further comprises:
a power supply receptacle formed in an external surface of the housing; and
a cover removably received by the external surface and substantially flush with the external surface;
the trailer electrical connector further comprises a power supply; and
the power supply:
is attached to the cover such that the power supply is received by the power supply receptacle when the cover is received by the external surface; and
powers the at least one visibility light source; and
the at least one visibility light source is within and attached to the cover.

10. The trailer electrical connector of claim 9, wherein the cover further comprises:
a first cover surface extending in a first direction substantially perpendicular to a length of the housing, wherein the at least one visibility light source is coupled to the housing at and located within the first cover surface;
a second cover surface extending in a second direction different from the first direction; and
a button located on the second cover surface and operable to remove the cover from the external surface.

11. The trailer electrical connector of claim 1, wherein the housing further comprises a magnet receptacle formed in an external surface of the housing and a magnet is within and attached to the receptacle such that the magnet does not move relative to the housing.

12. The trailer electrical connector of claim 11, wherein the at least one visibility light source is located within the housing on the opposite side of the housing as the magnet.

13. The trailer electrical connector of claim 1, wherein the housing comprises an external surface extending substantially perpendicular to a length of the housing and the at least one visibility light source is located within the external surface.

14. The trailer electrical connector of claim 13, wherein the external surface is substantially parallel to the electrical interface end.

15. The trailer electrical connector of claim 1, wherein the plurality of electrical connections are configured to mate with a plurality of vehicle electrical connections of a vehicle electrical connector and at least one visibility light source indicates a connection status between the trailer electrical connector and the vehicle electrical connector.

16. The trailer electrical connector of claim 1, wherein the at least one visibility light source faces toward the plurality of electrical connections.

17. The trailer electrical connector of claim 1, further comprising a switch located on or within the housing, wherein the switch is operable to selectively activate the at least one visibility light source independently of whether power is supplied to the plurality of electrical connections.

18. The trailer electrical connector of claim 1, wherein the at least one visibility light source is operable in at least one selectable modes, wherein the at least one selecting mode comprises at least one of: a high-intensity mode, a low-intensity mode, a strobe mode, an SOS signaling mode, a beacon mode, or an adjustable-focus mode.

19. The trailer electrical connector of claim 1, further comprising a rechargeable power supply housed within the housing, wherein the rechargeable power supply is configured to be recharged by at least one of: (a) a vehicle when the trailer electrical connector is electrically connected to the vehicle; (b) a trailer battery; (c) a solar panel coupled to the housing; or (d) an external power source.

20. The trailer electrical connector of claim 1, wherein the housing has a non-circular cross-sectional shape and the electrical interface end is configured to mate with a vehicle electrical connector having a vehicle electrical interface with four or more electrical connections.

21. The trailer electrical connector of claim 20, wherein the four or more electrical connectors are configured for at least one of: vehicle connection, accessory connection, safety connection, dormant connection, or blank connection.

22. A system, comprising:
a trailer electrical connector, comprising:
a trailer-connector housing comprising:
a front section defining a trailer electrical interface end of the housing; and
a rear section defining a trailer electrical cable engagement end of the housing and extending from the front section;
at least one visibility light source coupled to the trailer-connector housing;
a plurality of trailer electrical connections located at the trailer electrical interface end of the trailer-connector housing; and
a trailer-connector electrical cable attached to the trailer electrical cable engagement end of the trailer-connector housing; and
a vehicle electrical connector comprising:
a vehicle-connector housing comprising:
a vehicle electrical interface end; and
a vehicle electrical cable engagement end;
a plurality of vehicle electrical connections located at the vehicle electrical interface end of the vehicle housing and configured to mate with the plurality of trailer electrical connections; and
a vehicle-connector electrical cable attached to the vehicle electrical cable engagement end of the vehicle-connector housing.

23. The system of claim 22, wherein the vehicle electrical connector further comprises at least one vehicle-connector visibility light source coupled to the vehicle-connector housing.

24. The system of claim 23, wherein a length of the vehicle-connector housing extends in a first direction and the at least one vehicle visibility light source faces a second direction substantially perpendicular to the first direction.

25. A method, comprising:
activating at least one visibility light source coupled to a trailer connector housing of a trailer electrical connector, wherein the trailer connector housing comprises:
a front section defining a trailer electrical interface end of the trailer connector housing; and
a rear section defining an electrical cable engagement end of the trailer connector housing and extending from the front section;
connecting a plurality of trailer electrical connections located at the trailer electrical interface end of the trailer connector housing to a plurality of vehicle electrical connections located at a vehicle electrical interface end of a vehicle connector housing of a vehicle electrical connector; and
supplying electrical power to the plurality of trailer electrical connections and to the plurality of vehicle electrical connections via an electrical cable attached to the electrical cable engagement end of the trailer connector housing.
